(19) United States
(12) Patent Application Publication
(10) Pub. No.: US 2017/0114156 A1
(43) Pub. Date: Apr. 27, 2017

(54) NANOPORE WITH A CAVITY FOR FILTERING POLYMERS

(71) Applicant: Hendrick de Haan, Oshawa (CA)

(72) Inventor: Hendrick de Haan, Oshawa (CA)

(21) Appl. No.: 15/331,339

(22) Filed: Oct. 21, 2016

Related U.S. Application Data
(60) Provisional application No. 62/245,434, filed on Oct. 23, 2015.

(51) Int. Cl. C08F 6/04; B01D 61/08; B01D 69/12; B01D 61/02

(52) U.S. Cl. CPC C08F 6/04; B01D 61/027; B01D 61/08; B01D 69/12; B01D 2311/2603; B01D 2325/022

(57) ABSTRACT

Various embodiments are described herein a membrane that may be used to affect the translocation of polymers through at least one nanopore in the membrane by incorporating an enlarged cavity within the nanopore where the cavity size is selected along with an external force strength so that a translocation time of polymers through the nanopore is affected and may result in a non-monotonic function of polymer chain length, provide a low-pass application or a bioreactor application, for example. Various combinations of such membranes may be used in polymer filtration devices.

### CROSS-REFERENCE TO RELATED APPLICATION

This application claims the benefit of U.S. Provisional Patent Application No. 62/245,434 filed on Oct. 23, 2015; the entire contents of U.S. Provisional Patent Application No. 62/245,434 are hereby incorporated by reference in its entirety.

### FIELD

Various embodiments are described herein for the confinement and/or translocation of polymers through nanopores.

### BACKGROUND

The translocation of polymers through nanopores has been the subject of a great deal of research, motivated by its prevalence in natural systems as well as its many technological applications. The majority of studies of translocation have thus focused on a simple geometry consisting of a cylindrical hole through a membrane as a basic model for synthetic pores.

### SUMMARY OF VARIOUS EMBODIMENTS

In a broad aspect, at least one embodiment described herein provides a membrane for affecting the translocation of polymers therethrough, wherein the membrane comprises: a first side having a cis opening; a second side having a trans opening, the second side being located opposite the first side; and a nanopore extending between the cis opening of the first side to the trans opening of the second side, the nanopore including a cavity that has a cavity size that is selected to affect translation time of polymers having certain chain lengths when the nanopore is influenced by an external force.

In at least some embodiments, the cavity size is selected so that translocation time of polymers across the membrane during use is a non-monotonic function of polymer chain length when a given external force is applied to the nanopore.

In at least some embodiments, the inner cavity may be coaxially aligned with the nanopore.

In at least some embodiments, the cavity may have a cylindrical shape, may be symmetrically disposed about a longitudinal axis of the nanopore and may be wider than a first portion of the nanopore adjacent the cis opening and a second portion of the nanopore adjacent the trans opening.

In at least some embodiments, the cavity may have a radius equal to a length of the cavity.

In at least some embodiments, the cavity width may be equal to a monomer size of the polymer.

In at least some embodiments, the cis opening and the trans opening may have different shapes. Alternatively, the cis opening and the trans opening may have a common shape.

In at least some embodiments, the cavity may be asymmetric along the length of the nanopore.

In at least some embodiments, the membrane may be a composite membrane with a first layer comprising the cis opening, a second layer comprising the nanopore and a third layer comprising the trans opening.

In at least some embodiments, the membrane may comprise at least one additional cis opening, trans opening, and nanopore with an enlarged cavity to facilitate increased polymer filtration.

In another broad aspect, at least one embodiment described herein provides a device for affecting the translocation of polymers, wherein the device comprises an input reservoir for containing a plurality of input polymers; an output reservoir for containing a plurality of translocated output polymers; a membrane comprising a cis opening, a trans opening and a nanopore having an enlarged cavity, the membrane being fluidly coupled to the input reservoir via the cis opening to receive the input polymers and being fluidly coupled to the output reservoir via the trans opening to provide the translocated output polymers to the output reservoir, the cis opening and the trans opening being disposed on opposite surfaces of the membrane and being coupled to one another by the nanopore; and an external force source to apply an external force to the nanopore having a strength that is selected based on a cavity size of the cavity and a chain length of a given polymer to affect the translation of the given polymer across the membrane during use.

The nanopore may be defined according to the various embodiments described in accordance with the teachings herein.

In at least some embodiments, the external force source may comprise a voltage source with a first terminal coupled to a surface of the membrane having the trans opening and a second terminal of opposite polarity to the first terminal coupled to the cis opening to produce an electric field across the membrane in use.

In at least some embodiments, the external force source may comprise at least one of a pressure source to provide a pressure difference as the external force and a magnetic source to provide a magnetic field as the external force when magnetic beads are attached to the input polymers that permit manipulation of the polymers using magnetic forces.

In at least some embodiments, the external force may be strong enough to cause translocation to occur while not dominating over thermal motion occurring in the cavity.

In at least some embodiments, the external force may be increased during use to cause translocation time to have a strong dependent behavior on polymer length above a certain chain length to allow all polymers below the certain chain length to be translocated quickly across the membrane.

In at least some embodiments, the external force may be disabled during use to trap polymers within the nanopore and the cavity functions as a bioreactor when the cis and trans openings are small enough to present a barrier to the trapped polymer from exiting the cavity.

In bioreactor applications, at least one surface of the cavity may be functionalized with at least one of reactive groups, polymers, and strands of DNA of particular sequences for applications when the nanopore is operated as the bioreactor.

In at least some embodiments, the membrane may comprise a series of filtration units comprising nanopores having a corresponding cis opening, a corresponding trans opening, and an enlarged cavity to facilitate increased polymer filtration.

In at least some embodiments, the device may comprise a plurality of membranes arranged in parallel layers spaced apart from one another to increase polymer filtration with nanopores being aligned across different membranes.

In at least some embodiments, the external force may be changeable during use to allow a given nanopore to be dynamically tuned to filter polymers having a first polymer length at a first external force strength and a longer polymer length at a higher external force strength.

In at least some embodiments, the external force may be modified when processing a given sample or modified between processing different samples of polymers.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a cross-sectional diagram of a membrane having a nanopore.

FIG. 2 is a cross-sectional diagram of a membrane having a nanopore with a cavity in accordance with the teachings herein.

FIGS. 3A and 3B show translocation of a polymer through a nanopore and a nanopore with a cavity, respectively, in accordance with the teachings herein.

FIGS. 4A to 4C show various stages of translocation of a polymer through a nanopore with a cavity in accordance with the teachings herein.

FIG. 5 is a plot showing the numbers of monomers at the cis-side, trans-side and cavity as a function of time for the translocation of the polymer of FIGS. 4A-4C in accordance with the teachings herein.

FIGS. 6A to 6C, 6E and 6F show plots of translocation times, stuck times, exit times, average number of monomers in the cavity of a nanopore during the stuck phase, and average number of monomers in the cavity of a nanopore during the exit phase as a function of polymer chain size N at various field strengths in accordance with the teachings herein.

FIG. 6D shows translocation of a polymer through a nanopore with a cavity in accordance with the teachings herein.

FIG. 7 shows a plot comparing numerical measurements of critical polymer length N* as a function of effective radius of the nanopore cavity in accordance with the teachings herein.

FIG. 8 shows a device incorporating a membrane having a nanopore with an internal cavity in accordance with the teachings herein.

FIGS. 9A to 9C show various membranes having one or more nanopores with an internal cavity in accordance with the teachings herein and various arrangements of membranes.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to membranes and/or nanopores or methods having all of the features of any one membrane and/or nanopore described below or to features common to multiple or all of the membranes and/or nanopores described herein. It is possible that there may be a membrane and/or nanopore described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 10%, for example.

With their ability to detect and confine single biomolecules and biopolymers, nanopores have been proposed as a new platform for the detection, characterization, and manipulation of biological material at the nanoscopic scale. This application relates to various nanopore geometries for controlling the translocation of various biomolecules and biopolymers across a membrane. For example, at least one of the example embodiments described in accordance with the teachings herein may provide nanopores having cavities.

In another aspect, at least one of the embodiments of a nanopore having a cavity described in accordance with the teachings herein permits a molecule or polymer to translocate through the nanopore having a translocation time that is a non-monotonic function of chain length.

In another aspect, in at least one of the embodiments of the nanopore having a cavity described in accordance with the teachings herein, the translocation time may attain a well-defined minimum for a critical polymer chain length. Accordingly, such a nanopore may function as a filter to sort various molecules or polymers based on size or chain length. For example, at least one embodiment of a nanopore having a cavity described in accordance with the teachings herein may be able used to sort DNA by size.

In another aspect, in at least one of the embodiments of a nanopore having a cavity described in accordance with the teachings herein, the translocation time is long for small molecules or polymers as a result of entrapment within the cavity. In this case, such cavities that are capable of trapping molecules or polymers may function as a useful bioreactor which can be used to study the characteristics of the trapped molecule or polymer.

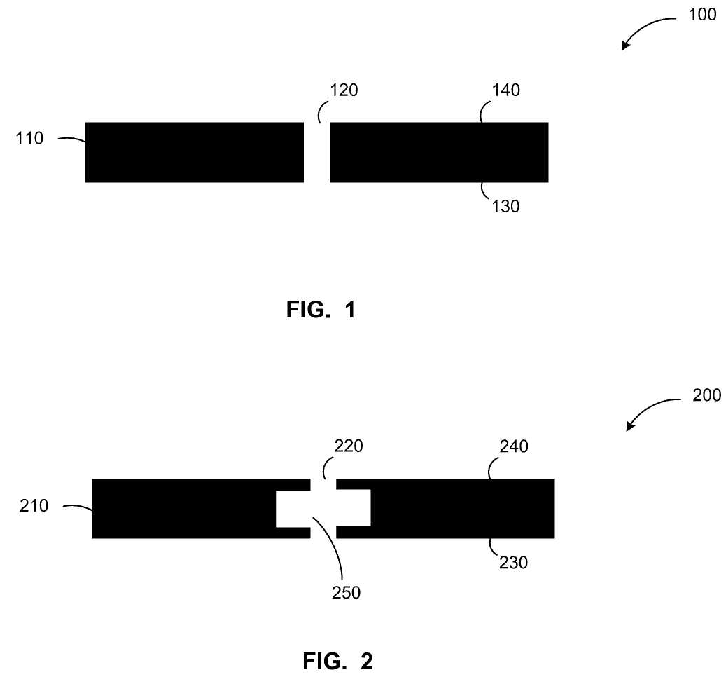

Referring now to FIG. 1, shown therein is a cross sectional diagram of an embodiment of a conventional membrane 100 having a known thickness 110 with a nanopore 120 extending from a cis-side 130 of the membrane 100 to a trans-side 140 of the membrane. The geometry of the nanopore 120 may comprise of a smooth cylindrical hole that traverses the membrane 100. The thickness of the nanopore 120 may be defined by the thickness 110 of the membrane.

The translocation time τₜᵣₐₙₛ may be defined as the time required for a polymer comprising a chain of N monomers to traverse the nanopore 120. The polymer may be freely-jointed or a polymer jointed in another fashion. This behavior may be described by a generally well defined power law in which translocation time may be scaled according to equation 1.

τₜᵣₐₙₛ·N^{∝} (1)

Numerical experiments generally suggest a value of ∝≈1.4 for a single nanopore and a value of ∝≈1.47 has been obtained in simulations when only the cis side nanopore is present (i.e. in the absence of the cavity and exit pore). This scaling relation may be explained with the tension propagation model. In this framework, translocation through a smooth nanopore 120 may occur in two stages. The polymer begins in a relaxed conformation, and is stretched out as translocation proceeds. The stretched conformation provides significantly more drag than the relaxed conformation, slowing translocation.

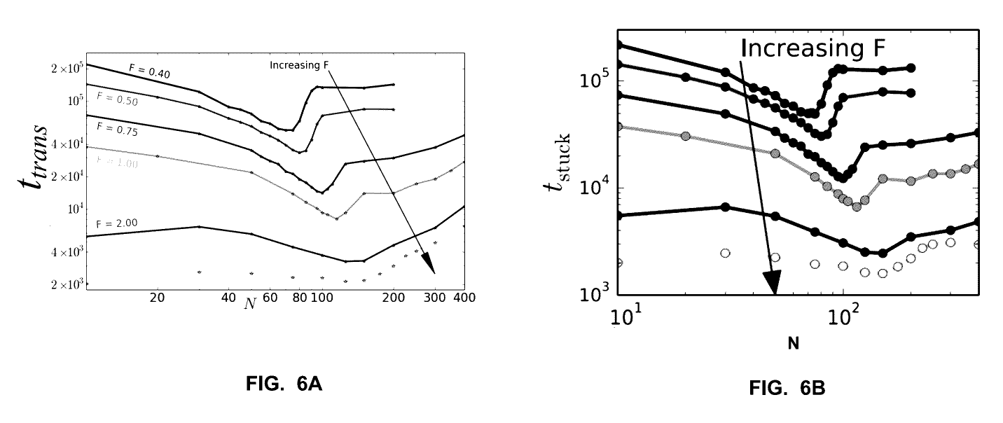

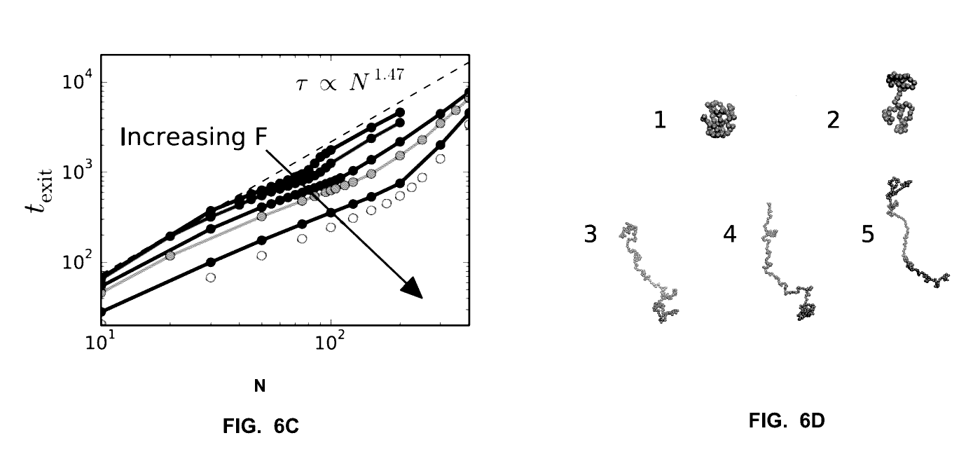

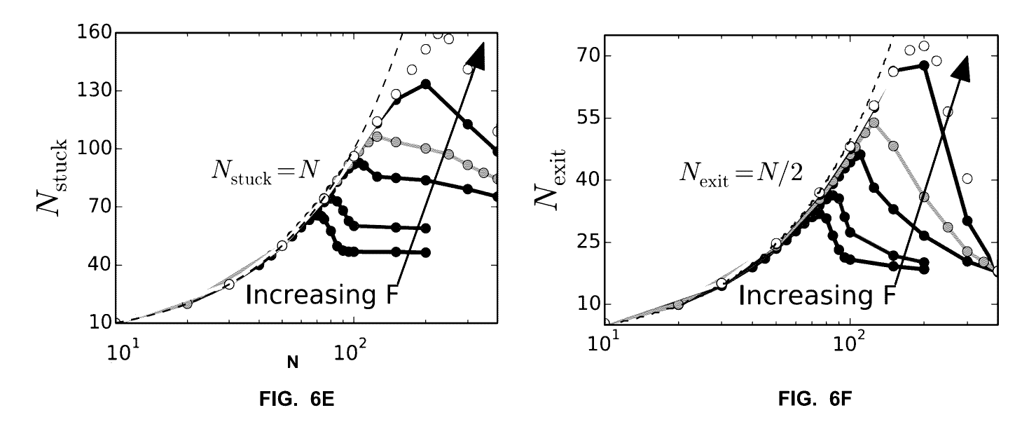

The translocation time being expressed as a power-law relationship with respect to N is quite robust for moderate changes in geometry. In experiments, the pores tend to be hour-glass shaped and there may be deviations from the cross-section being exactly circular. In simulations, pores have been built out of beads yielding rough, hexagonal shapes or other configurations with longer pore lengths and perhaps funnel type shapes. While the pre-factor and scaling exponent may change slightly with such details, tₜᵣₐₙₛ may be represented as a power-law in N for these types of geometries while for more complicated geometries, the relationship may be harder to predict since as shown in FIG. 6A, there may be different sets of scaling regimes.

On average, longer polymers may take longer to pass through the nanopore 120. Therefore, it may be conceivable that longer polymers such as, but not limited to, DNA may be filtered out by limiting translocation events to short times. However, a restriction that may be placed on the conventional nanopore 120 is that the scaling is robust and difficult to vary. In other words, translocation time for longer polymers may increase by a consistent amount such that the relationship between N and translocation time may be described as being monotonic.

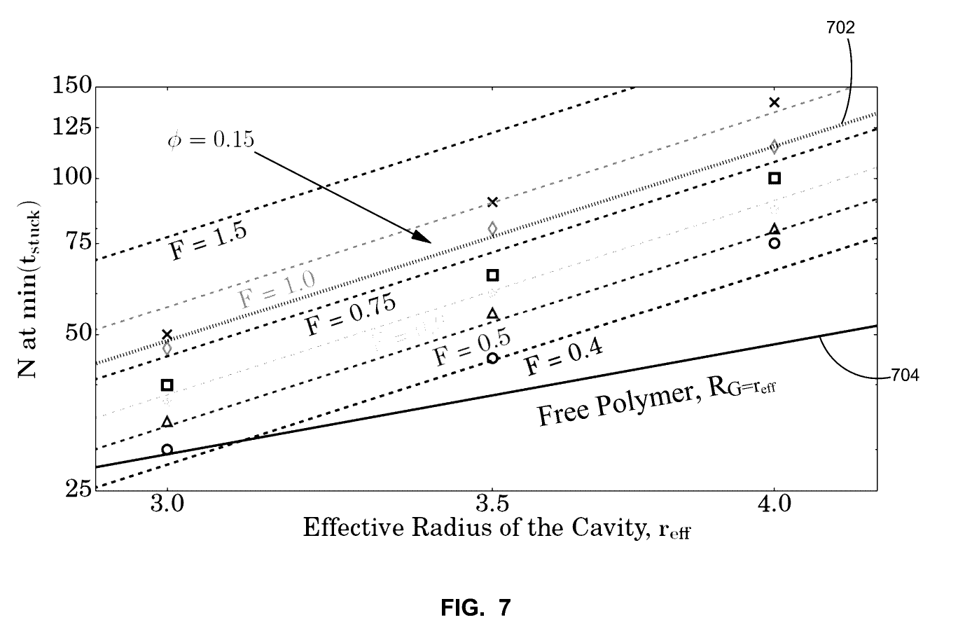

Referring now to FIG. 2, shown therein is a cross sectional diagram of an embodiment of a membrane 200 having a nanopore 220 extending from the cis-side 230 of the membrane 200 to the trans-side 240 of the membrane and having a thickness defined by the thickness 210. Additionally, the nanopore 220 includes a larger cavity 250 (i.e. the nanopore 220 comprises an enlarged cavity). Therefore, the nanopore structure may be described as comprising a narrow cylindrical hole with a wider, co-axial hole hollowed out of its interior. The structure may alternatively be visualized with respect to the entrance and exit from the nanopore 220 being comprised of narrower pores at the cis-side 230 and the trans-side 240 on either side of a larger, wider opening creating a cavity 250. Simulations using different cavity sizes, but the same aspect ratio and shape are shown in FIG. 7.

The thickness of the cavity 250 may be defined along the axis of the nanopore 220 in which the thickness or length of the nanopore 220 is defined. In some embodiments, the cavity 250 may be a smooth cylindrical hole with a radius equal to its length. As the cavity 250 grows, the membrane thickness 210 increases. According to the teachings herein, increasing the cavity size increases the length of a polymer that crosses the membrane 200 the fastest.

However, in some embodiments, other shapes and geometries as well as aspect ratios may be defined for the cavity 250. For example, the opening of the nanopore 220 at the cis-side 230 and the trans-side 240 may be different. In other embodiments, the cavity 250 may be asymmetric such that it is wider at one end relative to the other end, creating a funnel shape.

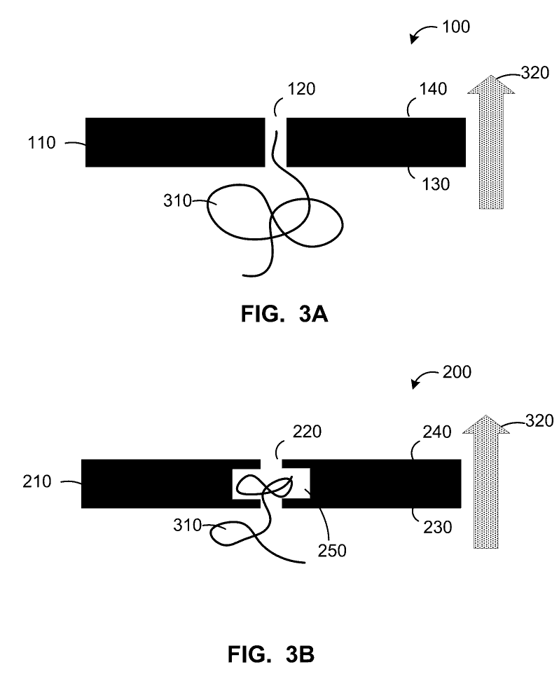

Referring now to FIG. 3A, shown therein is a conventional nanopore 120 wherein the application of an external electric field E of a desired strength may be used drive a polymer 310 through the nanopore 120. The externally driven electric field 320 may be applied having a gradient from the trans-side to the cis-side of the membrane 100 to move the polymer 310 from the cis-side 130 to the trans-side 140 of the membrane 100.

Referring now to FIG. 3B, shown therein is a nanopore 220 in accordance with the teachings herein wherein the application of the external electric field E of a desired strength may be used drive the polymer 310 through the nanopore 120. The externally driven electric field 320 is also applied having a gradient from the trans-side to the cis-side of the membrane 100 to move the polymer 310 from the cis-side 130 to the trans-side 140 of the membrane 100. However, the translocation time of the polymer 310 traversing the membrane 200 may be altered as a result of entropic trapping within the cavity 250 such that the scaling relationship between τₜᵣₐₙₛ and N may no longer be a simple power-law described above (the new relationship described in accordance with the teachings herein uses the notation tₜᵣₐₙₛ instead of τₜᵣₐₙₛ). As will be described in further detail subsequently, under some conditions, the relationship may be non-monotonic such that the translocation time is a minimum for a polymer of intermediate size with both shorter and longer polymers take longer to cross the membrane on average. Under other conditions, the translocation time may be independent of the polymer length up to a critical size after which a stronger dependence of the translocation time on the polymer length may be observed [i.e., α>1.47].

A study of the translocation time may be performed through event-driven computer simulation modelling to show the effect of the inner cavity 250 on tₜᵣₐₙₛ of a given polymer of length N in the presence of an external force, which in this case is provided by an electric field 320. The simulations may employ standard Langevin dynamics (LD) methodology. The simulation may be initialized with three monomers inside the nanopore 220, and the monomers in the cis can equilibrate. The monomer-monomer and monomer-pore excluded volume interactions may be modelled using the Weeks-Chandler-Andersen (WCA) potential and FENE bonds or any other appropriate bonding types known to those skilled in the art. The geometry of the nanopore 220 may be taken to be symmetric about the plane of the membrane 200. Simulations may be performed using known simulation packages such as ESPRESSO on the SHARCNET computer system, Matlab or customized computer code. One could use any number of other simulation packages known to those skilled in the art and get the same results, using standard parameters for both WCA and FENE. Visualization may be implemented using VMD.

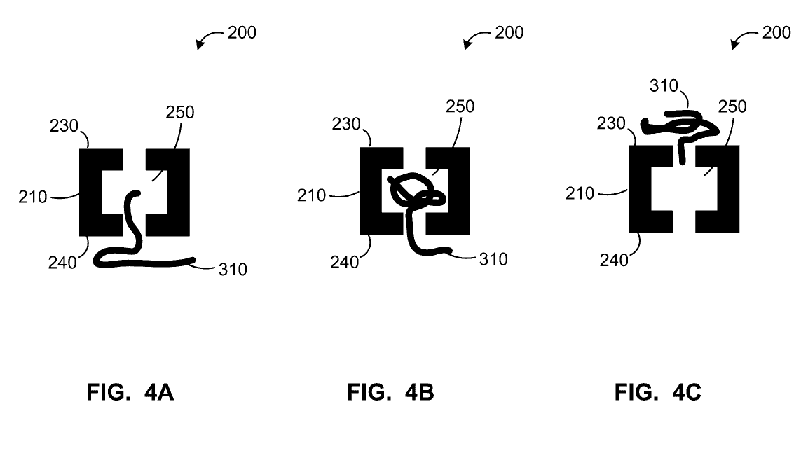

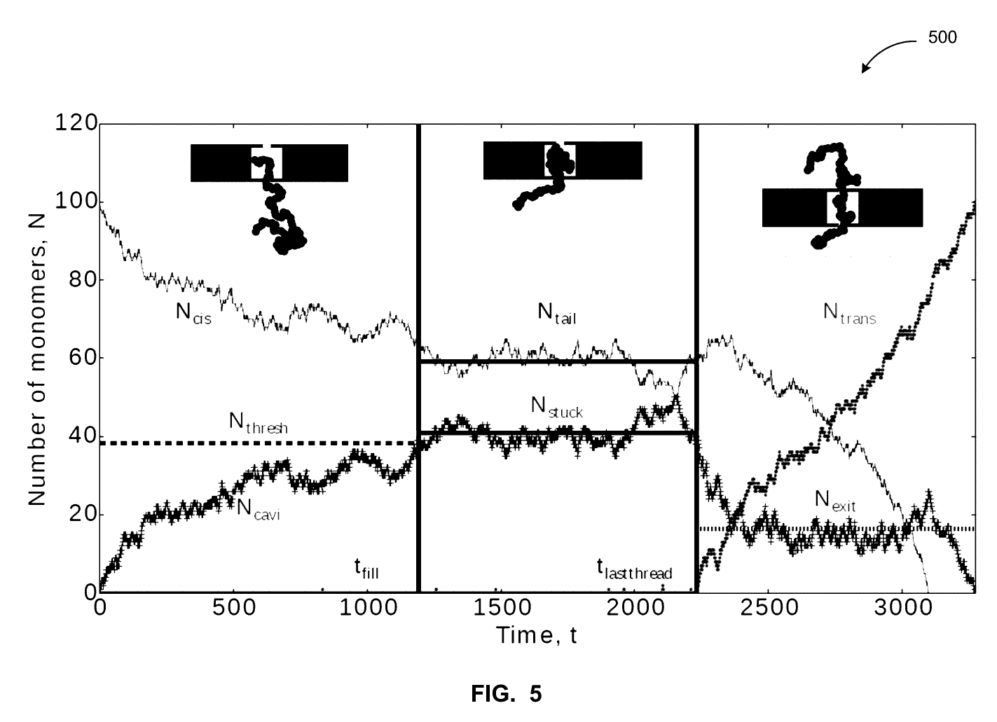

Referring now too FIGS. 4A to 4C and FIG. 5, shown therein are the various stages of a simulated translocation of the polymer 310 through an embodiment of the membrane 200 in which the nanopore 220 is cylindrical and the cavity 250 is cylindrical, co-axial with the nanopore 220 and has a larger radius then the entrance and outlet of the nanopore 220. The external field 320 (not shown) may be applied with a gradient from the trans-side 240 to the cis-side 230 to cause the polymer 310 to move from the cis-side 230 to the trans-side 240 of the membrane 200. The approximations of the field that may be used that involve having a constant force of one magnitude on monomers in the cis/trans pore and a constant force of a lower magnitude (as shown in equation 2 below) in the cavity.

The entrances to the nanopore 220 may have effective opening radii and thicknesses equal to the monomer size σ (i.e. this thickness is the portion of the membrane 200 from the outside environment through the cis-side 230 to the adjacent beginning of the cavity 250). However, in other embodiments, the radii and thicknesses may be different from the monomer size. With respect to the cavity 250, various cavity sizes, and cavity width to cavity thickness ratios may be possible. In the present embodiment, the effective cavity thickness may be maintained at about twice the cavity width to provide a significant barrier to the polymer 310 from escaping the cavity 250 so as to permit entropic trapping to occur. The entropic trapping effect may be enhanced when the radii of the entrance/exit pores of the cavity 250 are of a size that the polymer 310 must thread through via an end. Adding semi-flexibility (i.e. a persistence length) to the simulations may influence the choice of entrance/exit pore widths as well.

FIG. 4A depicts the initial stages of a simulated translocation process using a nanopore in accordance with the teachings herein. One end of the polymer 310 enters the nanopore 220 at the cis-side 230 of the membrane 200. The initial configuration of the simulation may assume that a number of leading monomers on the polymer chain have already been threaded into the cis opening of the nanopore 220 and reached the cavity 250. Thus, these leading monomers may be fixed along the nanopore axis as the rest of the polymer 310 is allowed to equilibrate outside of the nanopore 220. The state of the polymer and membrane structure of this example embodiment at each point in time may be characterized by the parameters N_{cis}, N_{cavi}, and Nₜᵣₐₙₛ to denote the number of monomers on the cis-side 230 of the membrane, the number of monomers inside the cavity 250, and the number of monomers on the trans side 240 of the membrane 200, respectively. Thus, for example, a polymer having chain length N initially with 3 monomers inside the nanopore cavity 250 has N_{cis}=N−3, N_{cavi}=3, and Nₜᵣₐₙₛ=0. The simulation may be terminated when Nₜᵣₐₙₛ=N, which indicates successful translocation, or N_{cis}=N, which indicates a failed translocation attempt.

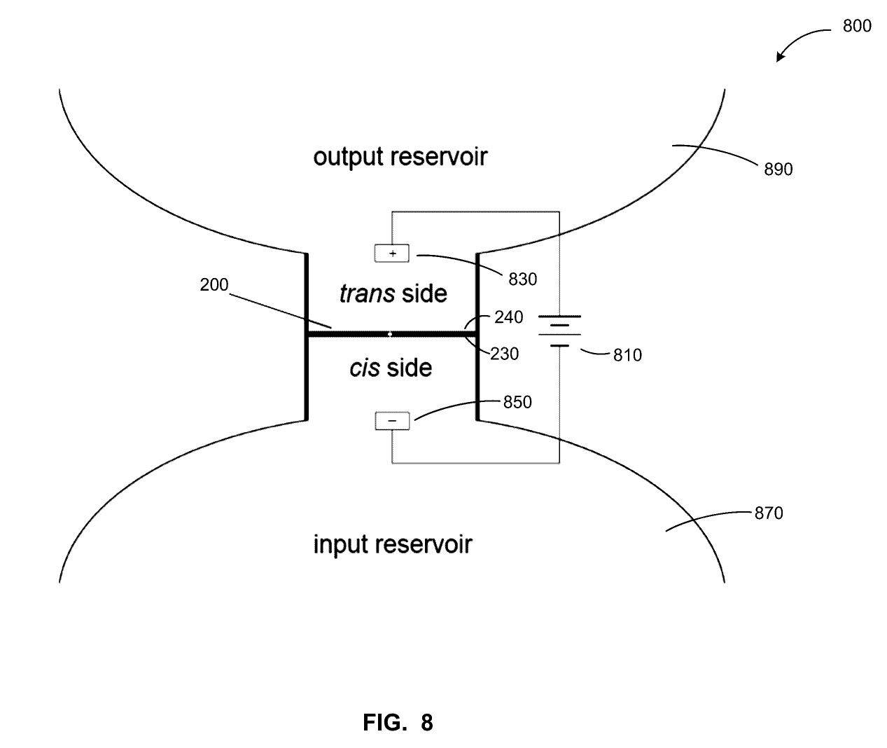

Translocation of the polymer 310 may be induced with the application of various types of external driving forces. For example, in some embodiments, application of fluid flow via a pressure difference may be used as a driving force. In this case a pressure source is used to provide a pressure difference as the external force. In other embodiments, a magnetic source that provides a magnetic field as the external force may be used when magnetic beads are attached to the polymer 310 to permit manipulation of the polymer 310 using magnetic forces. As described previously, an external electric field E may be applied in the embodiments described in accordance with the teachings herein to drive the polymer 310 through the membrane 200. In the simulation, the application of the external field 320 may be mimicked by a force defined by F=qE, where q=1 is the charge on each monomer. This field may be applied to all monomers in the nanopore to induce translocation of the polymer 310 such that the force may be approximated as being everywhere parallel to the longitudinal axis of the nanopore 220. This approximation is generally known to be reflective of actual field profiles. For example, as shown in FIG. 8, when an external field is applied cross the two terminals, the voltage drop between them may take place entirely over the nanopore such that the field outside the pore is small in comparison. The magnitude of the force at the nanopore 220 Fₚₒᵣₑ may be set equal in the cis and trans entrances, and the appropriate magnitude inside in the cavity Fₚₒᵣₑ may be approximated by the following relation shown in equation 2:

$${F}_{cavi} = {{F}_{pore} ( \frac{{r}_{pore}}{{r}_{cavi}} )}^{2} \qquad ( 2 )$$

which corresponds to the conservation of electric flux. The quantities rₚₒᵣₑ and r_{cavi} are the radius of the cis entrance and trans exit pores and the radius of the cavity, respectively.

Shown in FIGS. 4A and FIG. 5, is the initial state of the translocation process. At this stage, monomers thread into the cavity 250 from the cis side 230 of the membrane 200. At the same time N_{cavi} may increase steadily until the cavity 250 becomes “full”, i.e. when N_{cavi} exceeds some threshold value Nₜₕᵣₑₛₕ. The time required for N_{cavi} to reach Nₜₕᵣₑₛₕ may be denoted by t_{fill}. Thereafter, the polymer 310 may be “stuck” in the cavity 250, during which time the polymer 310 may not thread back to the cis side 230 nor successfully begin threading through the trans side 240. Also shown in FIG. 5 is that the stuck state may last a time denoted by t_{stuck} where the average number of monomers “stuck” in the cavity 250 may be denoted by N_{stuck}. For short polymers, translocation times may be large because they may become stuck in the cavity 250. This suggests that longer t_{stuck} may allow the cavity 250 to function as a bioreactor where small polymers and even biomolecules are confined and subject to particular processes. In some embodiments, it may be preferable to entrap a small polymer for long time durations. To do so, the external field 320 applied to induce translocation may be disabled, such that the smaller openings at either ends of the cavity result in bottlenecks in which escape in either direction may be prevented.

In at least some embodiments, for bioreactor applications for example, at least one of the surfaces of the cavity may be functionalized with at least one of reactive groups, polymers, and strands of DNA of particular sequences.

In at least some embodiments, the membrane 200 may be fabricated by creating the cis entrance, cavity, and trans exit as pores in separate membrane layers that are then layered together to create a composite system in the central axis of these pores are aligned. In at least one of these embodiments, for applications as a bioreactor, the interior cavity containing membrane may be functionalized prior to layering these membranes together.

Referring now to FIG. 4B and FIG. 5, shown therein is a polymer tail formed by the majority of monomers remaining on the cis side 230 of the membrane 200 that are not in the cavity 250. The length of the polymer tail whilst a portion of the polymer 310 is stuck in the cavity 250 may be denoted by Nₜₐᵢₗ. The polymer 310 may be considered stuck until the last time at which Nₜᵣₐₙₛ is zero; this point in time may be referred to as t_{last thread}.

Attempts by the polymer 310 to thread through the trans side 240 of the membrane 200 may eventually be successful, at which point the polymer 310 exits the cavity 250 through the trans side 240 of the membrane 200 until Nₜᵣₐₙₛ=N as shown in FIG. 4C. This exiting stage may last for a time duration of tₑₓᵢₜ, and the average number of monomers in the cavity 250 during this time may be denoted by Nₑₓᵢₜ as shown in FIG. 5. The polymer 310 completes the translocation process after a total length of time tₜᵣₐₙₛ.

FIG. 5. visually summarizes the above described translocation process as a function of the number of monomers in the polymer 310 and the time duration at various locations of the membrane 200. At the initial state, monomers in the polymer 310 may thread into the cavity 250 from the cis-side 230 of the membrane 200 for a time duration of t_{fill} until N_{cavi} exceeds some threshold value Nₜₕᵣₑₛₕ. Thereafter, the polymer 310 may be stuck in the cavity 250 for a time duration of t_{stuck} during which time N_{cavi} may fluctuate near some mean value N_{stuck}. The majority of monomers not in the cavity 250 may remain on the cis-side 230 of the membrane 200 forming a tail having an average length of Nₜₐᵢₗ. The polymer 310 may be stuck until the last time tₗₐₛₜ_{_}_{thread} at which Nₜᵣₐₙₛ is zero. Thereafter, the polymer 310 may begin exiting the cavity 250 through the trans-side 240 of the nanopore 220. This exiting stage may last a duration tₑₓᵢₜ, and Nₑₓᵢₜ may be the average number of monomers in the cavity during this time. Finally, the chain completes the translocation after a total length of time tₜᵣₐₙₛ.

The parameter Nₜₕᵣₑₛₕ may be used to indicate a value of N_{cavi} that may only be exceeded when the polymer 310 is in the stuck regime. The value of N_{cavi} may be subject to random fluctuations such that it is generally not well-defined. For example, polymers with short chain lengths may be short enough to remain completely confined in the cavity 250 before tₗₐₛₜ_{_}_{thread} in which case Nₜₕᵣₑₛₕ=N. For longer polymers, Nₜₕᵣₑₛₕ may also be N where the polymer chain has a radius of gyration equal to the radius of the cavity 250. To minimize bias introduced by the choice of Nₜₕᵣₑₛₕ, the average of N_{stuck} may be weighted by t_{stuck}. Since the choice of Nₜₕᵣₑₛₕ may only introduce a transient bias in data collected near the beginning of the stuck regime, this bias may be relatively smaller for events where t_{stuck} is larger.

In some embodiments, the polymer 310 may pass “straight-through” the cavity 250, successfully threading through the trans-side 240 membrane 200 before any portion of the polymer 310 becomes trapped in the cavity 250. As a result, the stuck phase described may not be well-defined. Furthermore it is unlikely that N_{cavi} may increase beyond Nₜₕᵣₑₛₕ=N for the straight-through events, so that the maximum value of N_{cavi} over time may be used to identify such events. Lastly, straight-through events may be very rare, with simulation results indicating that they may account for less than 1 in every 1000 successful translocation events.

FIGS. 6A to 6F show five metrics (tₜᵣₐₙₛ, t_{stuck}, tₑₓᵢₜ, N_{stuck} and Nₑₓᵢₜ) for a simulation of the embodiment of the membrane 200 described in FIGS. 4A to 4C. The metrics indicate that the translocation behavior described thus far may not hold under circumstances where the external force 320 is too strong (e.g. the force dominates over thermal fluctuations such that entropic trapping is negligible).

As shown in FIG. 6A, the total length of time tₜᵣₐₙₛ required for total translocation of the membrane 200 may be a non-monotonic function of N as shown in equation 3:

tₜᵣₐₙₛ=t_{fill}+t_{stuck}+tₑₓᵢₜ (3)

when considering each term of the summation individually. It should be noted that in some embodiments, the contribution of t_{fill} may be much smaller than the other two terms. For polymers less than the critical length, t_{stuck} may dominate t_{fill}, while for polymers larger than the critical length, tₑₓᵢₜ may dominate t_{fill}. Hence, for this analysis, t_{fill} may not play a crucial role.

FIG. 6B shows the behavior of t_{stuck} as a function of N at various driving force strengths, which suggests that t_{stuck} itself may be a non-monotonic function of N. For very small N, where R_{g}<<R_{cavity}, the polymer chain 310 may be completely inside the cavity 250 during the stuck phase. While the polymer chain 310 may be considered to be entropically trapped, the available volume within the cavity 250 may be reduced by the excluded volume interactions between monomers. Thus, the strength of the entropic trapping may decrease with more monomers in the cavity. As N grows, the available volume in the cavity 250 is reduced by the excluded volume interactions between the monomers of the polymer chain 310. Hence, the trapping effect decreases as N increases and t_{stuck} thus decreases. In other words t_{stuck} is dependent on N. Eventually t_{stuck}(N) may attain a minimum, as the polymer chain 310 may be sufficiently large to occupy the entire volume of the cavity 250, negating the entropic trapping effects. The value of N corresponding to a polymer chain 310 capable of filling the entire volume of the cavity 250 may be used to define a critical length N* for which t_{stuck} may be minimal. Further increasing N beyond N* may increase t_{stuck}, which may be attributed to the formation of a tail on the cis-side 230 of the nanopore 220 of the membrane 200. More specifically this tail can grow rapidly with N. The formation of the tail can fundamentally change the dynamics of the stuck phase. When the tail exists, monomers can fluctuate in and out of the cavity. This fluctuation can be used to mark a transition from the closed confinement to open confinement for the stuck conformation of the polymer. An entropic barrier to exit may be greater when the tail is present, since open confinement can be less restrictive than closed confinement. Thus, the formation of the tail can lead to a more rapid increase of t_{stuck}.

For large N where R_{g}>R_{cavity}, the polymer chain 310 may not fit entirely within the cavity 250 and thus entropic trapping does not occur such that t_{stuck} is independent on N. However, as N grows, the time to exit tₑₓᵢₜ via the trans-side 240 also increases since there are more monomers to translocate. Thus, the combined effects described create is a well-defined minimum at a critical polymer length N* for which the translocation time is lowest.

The value of t_{stuck} may be increased by the presence of a polymer tail in two ways. In the first case, the motion of the polymer tail may reduce the net entropic force driving translocation of the polymer 310 through the trans-side 240 of the membrane 200. In the second case, the polymer tail may cause a reduction of N_{stuck} below N*, as shown in FIG. 6E such that the volume available to monomers in the cavity 250 may be increased, making the entropic trapping again more appreciable when N>N* than when N=N*. Additionally, under circumstances where Nₜₐᵢₗ may be appreciable, the polymer tail may provide a means for the monomers to exit the cavity 250 through the cis-side 230 of the membrane 200. Generally, this exit would be a rare occurrence when no polymer tail is present since the force of the external field 320 at the cis-side 230 of the membrane would be strong and push the monomers of the polymer 310 in the direction of the cavity 250.

Increasing N further, the corresponding change in t_{stuck} may flatten out as N_{stuck} converges to some limiting value as shown in FIG. 6E. This behavior suggests that the entropic trapping effects may have become saturated. For even larger values of N, t -trans may become dominated by tₑₓᵢₜ.

The behavior of t_{stuck} described thus far may change as the driving force created by the external field 320 becomes sufficiently strong to cause this change. In circumstances where the driving force in the cavity 250 is strong enough to suppress the thermal motion of the monomers, the polymer chain 310 may be very close to the trans-side 240 of the membrane 200 during the stuck phase. As a result, the effectiveness of the entropic trap may be significantly reduced. Similarly, when the driving force at the cis-side 230 of the membrane 200 is increased, the monomers may be less likely to exit the cavity 250 through the cis-side 230 of the membrane 200 along the polymer tail. The combined effects of suppressing the entropic behaviors due to larger driving forces may result in a flattening of t_{stuck}(N) at larger driving forces as shown in FIG. 6B. In addition, it should be known that increasing F may shift the minimum translocation times to larger values of N. Hence, within a certain range of applied field strength 320, the membrane may be dynamically tuned to optimize for desired polymer lengths N by altering the applied field strength 320. Secondly, at large applied forces, the non-monotonic behavior may become negligible such that translocation time becomes independent of polymer length N up to a critical length, after which translocation time may become dependent on N.

Referring now to FIG. 6C, shown therein is a plot of tₑₓᵢₜ as a function of N of the membrane 200. The graph shows that tₑₓᵢₜ can be a monotonic function of N, but does not necessarily obey the universal power law relation. For short polymer chains (i.e. small N), the plot suggests that tₑₓᵢₜ may scale according to N^{1.47}, similar to the translocation time of a polymer 310 through a conventional nanopore 120 of membrane 100 (see FIG. 3A) which lacks a cavity. Such behavior may result since shorter polymer chains 310 may be able to fit entirely within the cavity 250 during the stuck phase so that the exit translocation closely resembles passage through a conventional nanopore 120. However, the difference compared to conventional nanopores is that the monomers in the cavity 250 may still be subject to a driving force, which is apparent in the high-force plot lines of FIG. 6C.

With increasingly longer polymer chain length (i.e. increasing N), the scaling of tₑₓᵢₜ(N) may deviate from the “normal” scaling law N^{1.47} such that tₑₓᵢₜ ∝ N^{α} for which α<1.47. FIG. 6C suggests that for larger N, the scaling may transition to α>1.47. This behavior may be understood using the tension propagation model of polymer translocation.

For small N, Nₜₐᵢₗ may correspondingly be small. During the exit process, the short tail may refill the cavity 250 from the cis-side 230 of the nanopore 220 as quickly as the leading end of the polymer 310 exits via the trans-side 240 of the nanopore 220. The cavity 250 may ensure that the polymer 310 is always in a compressed conformation shown in panel 2 of FIG. 6D, so tension propagation cannot take place. The drag of the extended polymer conformation is absent, so translocation is faster than for an unconfined chain.

As N is increased beyond N*, Nₜₐᵢₗ may increase rapidly, and N_{stuck} and Nₑₓᵢₜ may decrease correspondingly, as shown in FIGS. 6E and 6F. The decrease in N_{stuck} may signify a change in the conformation of the polymer 310 at the beginning of the exit process from a compressed state to an elongated state shown in panel 3 of FIG. 6D. The sharp decrease in Nₑₓᵢₜ may suggest that longer polymer chains spend most of the exit process in an extended conformation between the cis- and trans-sides of the nanopore 220 shown in panel 5 of FIG. 6D. In this conformation, tension may propagate along the polymer chain even more rapidly than during translocation through a conventional nanopore 120 so that α>1.47. Thus, for low to moderate applied forces, the translocation time may increase rapidly as polymer length N increase beyond a critical N value (N*) as a result of the emergence of a tail on the cis-side 230. The increase in translocation time thus yields a well-defined minimum, for conditions where N>N*.

As N is increased even further (i.e. Nₜₐᵢₗ>>N_{stuck}), the exit translocation may become dominated by the translocation of the polymer tail through the cis-side 230 of the nanopore 220. In this limit, a typical scaling relation of α>1.47 can be observed. This may be observed in FIG. 6C for application of low forces.

Increasing the driving force may affect the behavior of the polymer 310 during the exit translocation process. For example, when a stronger driving force is applied, short polymer chains may no longer remain in a relaxed state during the stuck phase but may instead be compressed against the trans-side 240 of the membrane 200. Similarly, as F increases, the effect on the tail of a polymer 310 may also become less important. The relaxation time for the monomers within the cavity to reach a compressed state may also be reduced so that tension propagation may be suppressed for larger values of N.

Additionally, varying the strength of the external field 320 may also change the location of the value of N at which tₜᵣₐₙₛ reaches a minimum. As shown in FIG. 6A, varying the field from 0.4 to 1.0 (in dimensionless units) may move the minimum from N≈60 to N≈100. Thus, a nanopore 220 of a given size may be dynamically tuned during use to be optimized for particular polymer lengths by altering the magnitude of an externally applied force within in an appropriate operational range determined for the particular application at hand. Possible applications which may take advantage of this result may include the ability to filter polymers based on polymer length from a polymer sample containing polymer chains of varying lengths.

FIG. 6A also suggests that the non-monotonic behavior of the total translocation time may disappear when the applied force becomes sufficiently large. In this case, tₜᵣₐₙₛ may be constant for N<N* as the increase of tₑₓᵢₜ may balance the decrease of t_{stuck}. However, for N>N*, tₜᵣₐₙₛ may increase rapidly, as the formation of a tail causes t_{stuck} to stop diminishing and tₑₓᵢₜ to grow rapidly. The combined effect may be a transition point where tₜᵣₐₙₛ ∝ N^{α} may suddenly change from α≈0 to α>1.47. This change of a may indicate that translocation time is independent of polymer length N up to a certain point, after which the translocation time may become strongly dependent on polymer length N. In other words, for large applied forces, all polymers below a certain length N may translocate quickly while longer polymers may take much more time to translocate. This difference in translocation times may allow for a method of polymer filtration where all polymers below a given threshold length may be extracted, for example. In other words, operating in this regime may result in the nanopore acting as a low-pass filter with dynamically-adjustable thresholds and strong N dependence above the threshold.

The behavior described above suggests that inclusion of an internal cavity 250 may yield a more variable scaling of the translocation time of a polymer 310 through membrane 200. Most notably, tₜᵣₐₙₛ may increase non-monotonically with N, as shown in FIG. 6A. In other words, instead of tₜᵣₐₙₛ increasing steadily with increasing polymer length, tₜᵣₐₙₛ may reach a minimum for an intermediate chain length where both longer and shorter polymer chains may require more time to traverse the membrane 200. Therefore, variation of the cavity size may be another method of filtering polymers of different lengths through the membrane, as shown in FIG. 7, for a constant external force. Furthermore, for a given cavity size, the location of the minimum critical polymer length may also be varied based the applied field strength. Adjustment of the field strength during use of the membrane within a system (an example of which is illustrated in FIG. 8) may allow for dynamic tuning.

Referring now to FIG. 7, shown therein is a plot of critical polymer length N* as a function of different cavity radii at various external field strengths (i.e. external force) that are applied to the membrane 200 (see FIGS. 4A to 4C). FIG. 7 suggests at least a mild non-monotonic translocation behavior. Otherwise, the plot suggests that the translocation time may be shortest for the shortest polymer lengths.

The teachings herein allow for a model that may be used to obtain an analytic estimate of N*. At low forces, tₜᵣₐₙₛ may be dominated by t_{stuck} near N* so that their minima approximately coincide. Furthermore, the minimum of t_{stuck} can occur when the entropic trapping effect is minimized as a result of N_{stuck} being maximized. Thus, the chain length that minimizes t_{stuck} can be estimated by modelling the maximum number of monomers that can fit in the cavity, and this value should be close to N* at low forces.

Assuming the maximum N_{stuck} occurs when Nₜₐᵢₗ≈0, the mode can consider a polymer that is completely contained inside the cavity 250. In the stuck phase, the chain can reach equilibrium: the calculated polymer relaxation times can be significantly smaller than the stuck times as shown in FIG. 6B for all critical lengths. Thus, the model will consider a polymer at equilibrium inside the cavity 250, ignoring the entrance and exit pores.

For example, consider a polymer 310 of length N trapped in the cavity 250 such that it fills the cavity 250 completely and has a tail comprising a single monomer. Also assume that no monomers have threaded through the trans-exit to the nanopore 220. The above analysis may be used to show that this is the average conformation for polymer chains that may minimize t_{stuck}. The maximum occupancy can be estimated via the free energy of this polymer. The entropic cost to confining the polymer can be offset by the external electric field. The difference in this free energy may be expressed as shown in equation 4:

A=A_{conf}−A_{force} (4)

where A_{force} is is the energy cost to the driving field 320, and A_{conf} is the cost of confining the chain in the cavity 250. For short chains, as N increases, the decrease in free energy due to the electric field is greater than the increased cost of confinement, so A may decrease with N for small values of N. Conversely, for long chains, the entropic cost of confinement can grow rapidly, and A can increase with N. Thus A has a minimum at intermediate chain lengths. It may be possible that A is minimized near N*.

The free energy due to the driving field may further be described as shown in equation 5:

$${A}_{force} = {\tilde{F}}_{cis} \frac{σ}{2} + ( N - 1 ) {\tilde{F}}_{cis} σ + {\sum }_{i = 1} N {\tilde{F}}_{cavi} {d}_{i} \qquad ( 5 )$$

where

$${\tilde{F}}_{cis} \frac{σ}{2}$$

is the energy to insert the final monomer into the cis entrance, (N−1)\tilde{F}_{cis}σ is the energy to insert all other monomers into the cavity, and Σᵢ₌₁N\tilde{F}_{cavi}dᵢ is the sum of the energies due to the positions dᵢ of the monomers within the cavity.

For the purpose of determining the value of N that may minimize A, the first term and the constant portion of the second term of equation 5 may be dropped because they do not depend on N. The third term of equation 5 may also be neglected where weak driving forces are applied in conjunction with large cavities (e.g. (rₚₒᵣₑ/r_{cavi})² is <<1 such that the field in the cavity is small) since the force inside such cavities may be much smaller than that at the openings to the nanopore. In such cases, A_{force}, which may be representative of the work done by the driving force to bring the polymer chain into the cavity 250, may be approximated by equation 6 when force effects within the cavity are neglected.

A_{force}≈N\tilde{F}ₚₒᵣₑσ (6)

where σ is the monomer size.

The free energy of confinement may be estimated using the relation for the free energy of confining a flexible polymer in a sphere:

$${A}_{conf} \sim {B ( \frac{{R}_{G}}{R} )}^{\frac{3}{3 v - 1}} \qquad ( 7 )$$

where R_{G} is the radius of gyration of the unconfined polymer, B is a constant, v≈0.588 is the Flory exponent and R is the radius of the spherical confinement.

As in much of polymer physics, the scaling relations may be obtained only up to a constant. The constant in this case has units of energy and represents the confinement energy for a polymer that has a radius of gyration in free space that is the same as the cavity radius: A_{cont}=B when R_{G}=R. One would expect this value to be on the order of kT, the thermal energy (which is set to 1 here). It was found that B was about 3.4, which is reasonable for this physical model. This relationship may be valid in the dilute limit where the total volume excluded may be a small fraction of the total cavity size. Corrections may be relevant for smaller cavities or stronger fields. The free energy of confinement may scale differently as the volume fraction of a polymer in the cavity becomes very high which may happen for strong fields. However, as this yields very high energies, it may be unlikely to ever be in this regime. For small cavities, the field inside the cavity may not be negligible for the reasons discussed above. Accordingly, strong fields may be strong enough to force packing of the monomers in the cavity, and small cavities may have rₚₒᵣₑ/r_{cavi} close to, but less than, 1.

Using R_{G}=C_{G}σN^{v} and R=r_{eff,cavi}, the expression for total free energy as a function of N may therefore be written as shown in equation 9.

$$A = {B ( \frac{{C}_{G} σ}{{r}_{eff , cavi}} {N}^{V} )}^{\frac{3}{3 v - 1}} - {NF}_{pore} σ \qquad ( 8 )$$

The length of minimum free energy may be found by setting the derivative of A with respect to N to be zero and solving for N as shown in equations 9 and 10.

$$\begin{matrix}\frac{\partial A}{\partial N} = 0 & ( 9 ) \\ \to {{N}_{theo}^{*}}^{*} ( \tilde{F} , R ) \sim {( \frac{3 v - 1}{3 v} \frac{{F}_{pore} σ}{B} )}^{3 v - 1} {( \frac{{r}_{eff , cavi}}{{C}_{G} σ} )}^{3} & ( 10 )\end{matrix}$$

This prediction for N* may hold up to some constant factor (e.g. B) independent of the size of the nanopore 220 and the magnitude of the driving force 320 as long as the driving force 320 is not too strong to force the packing of monomers into the cavity.

Referring now to FIG. 7, shown therein is a plot of the measured polymer length N at measured minima of t_{stuck} as a function of the effective nanopore cavity radius r_{eff,cavi} at various field strengths Fₚₒᵣₑ for the membrane 200. This figure compares equation 10 to simulation results as a function of r_{eff,cavi}. FIG. 7 suggests that the prediction of N* is consistent with numerical data for the field strengths that were simulated. The units for the external force are ε/σ where c is the thermal energy kT and σ is the monomer diameter. Both are set to one in the simulations so the simulation results are dimensionless. At low applied forces, t_{stuck} may be flat near its minima; in particular, although the minimum for r_{eff,cavi}=4.0σ, Fₚₒᵣₑ=0.4ε/σ is relatively far from equation 10, the trough in t_{stuck} can extend roughly from N=65 to N=75, which may be viewed as being in agreement with the predicted value of 66. In the present case, the plot is generated using C_{G}=0.402 as determined from simulations. The line 704 corresponds to a chain for which R_{G}=r_{eff,cavi}. As the predictions approach line 702, equation 10 may under-predict N*. Conversely, near line 704, the model may over-predict the cost of confinement so that equation 10 similarly under-predicts N*. Between these two limits of applicability, however, the model may show agreement with data.

These results suggest that the non-monotonicity of t_{trans(N)} may allow nanopore geometries which minimize translocation time for polymer chains of intermediate length rather than chains of short lengths. Furthermore, these results indicate that simple setups may be used to enable the extraction of specific polymers and for the purification of samples containing many polymers of varying lengths. As such, operating in the strongly non-monotonic regime can yield selective filtering effects (i.e. band-pass filtering) based on chain length. Additionally, equation 10 indicates that it may be possible to tailor design features to particular applications. For example, by changing the applied voltage, the nanopore structure may be tuned dynamically, within a desired range, to change the targeted polymer length. Both the band-pass filtering properties and low-pass filtering properties described previously may be used to enable possible uses of the nanopores such as in, but not limited to, nanobiotechnology devices.

Referring now to FIG. 8, shown therein is a device 800 incorporating the membrane 200 comprising the nanopore 220 with the cavity 250. The device 800 also comprises an external force source to apply an external force to the nanopore 220 and the membrane 200. In this example embodiment, the external force source is a voltage source 810 with first terminal (i.e. a positive terminal 830) coupled to the trans opening on the trans-side 240 and second terminal opposite in polarity to the first terminal (i.e. the second terminal is a negative terminal 850) coupled to the cis opening on the cis-side 230 which produces an electric field across the membrane 200 in use. Polymers to be translocated through the membrane 200 may be stored in the input reservoir 870 and collected after translocation at the output reservoir 890. Other types of forces may be applied as previously described so there may be other embodiments of the device 800 which include another type of force source to provide one of these alternative forces.

A nanopore comprising an internal cavity bounded by smaller openings at the cis-side 230 and the trans-side 240 may allow for the selective transport of polymers 310 of certain lengths or length ranges across the membrane 200. At low applied forces where the entropic trapping in the cavity 250 may be non-negligible, the translocation time may be non-monotonic as a function of the polymer length and reach a well-defined minimum for polymers of a specific length with both shorter and longer polymers taking longer to translocate. This internal cavity 250 may allow for polymers of a specific length to be extracted from a sample containing polymers of many lengths. In effect, the cavity structure 250 may allow for the fabrication of band-pass filters based on polymer length. Furthermore, nanopores having an enlarged cavity act as a better low pass filter at higher external forces than conventional nanopores since all polymers having a chain length shorter than a selected “cutoff” chain length (from choosing the cavity size and the external force strength) will have almost the same translocation time whereas conventional nanopore designs may not be particularly good low-pass filters as polymers with chain lengths below the cutoff chain length will have different translocation times.

Furthermore, filtration may be enhanced by disabling the external field 320 after the average translocation time corresponding to a desired polymer length has elapsed. This procedure may allow for the selective transport of polymers, a sequestration of shorter polymers within the cavity, or a retraction of longer polymers to the cis-side 230 of the membrane 200. Alternatively, there may be other filtration possibilities such as, but not limited to, using a driving force with an alternating component. With alternating external force strengths, it may be possible to achieve a form of resonance depending on the frequency of oscillation of the alternation and the polymer to cavity size ratio.

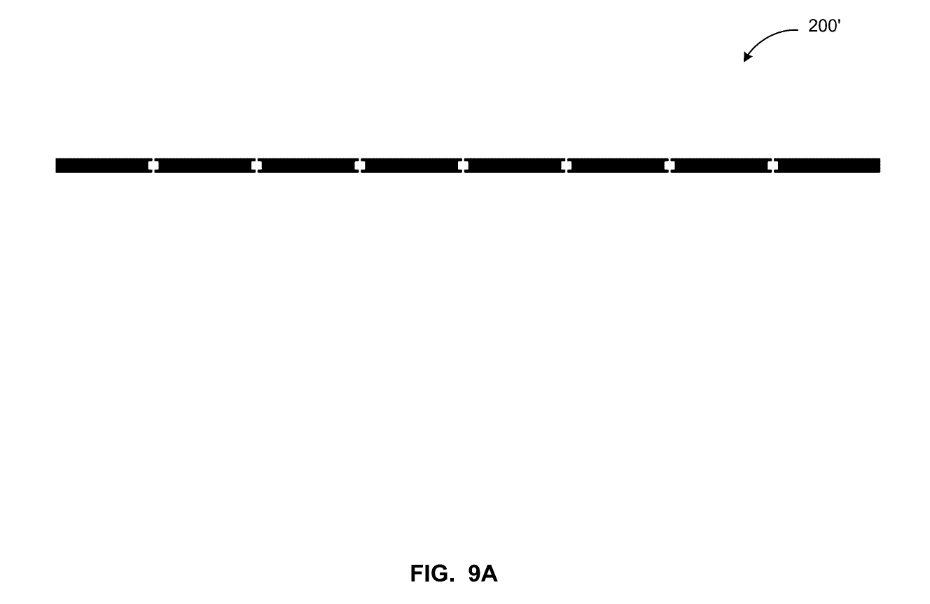

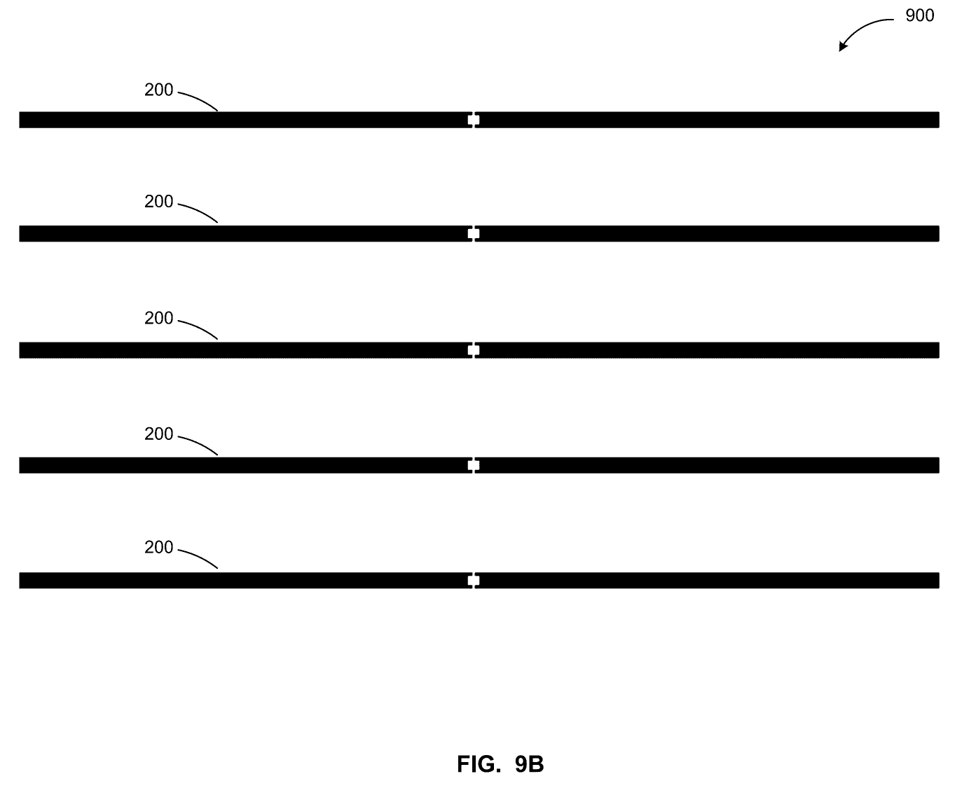

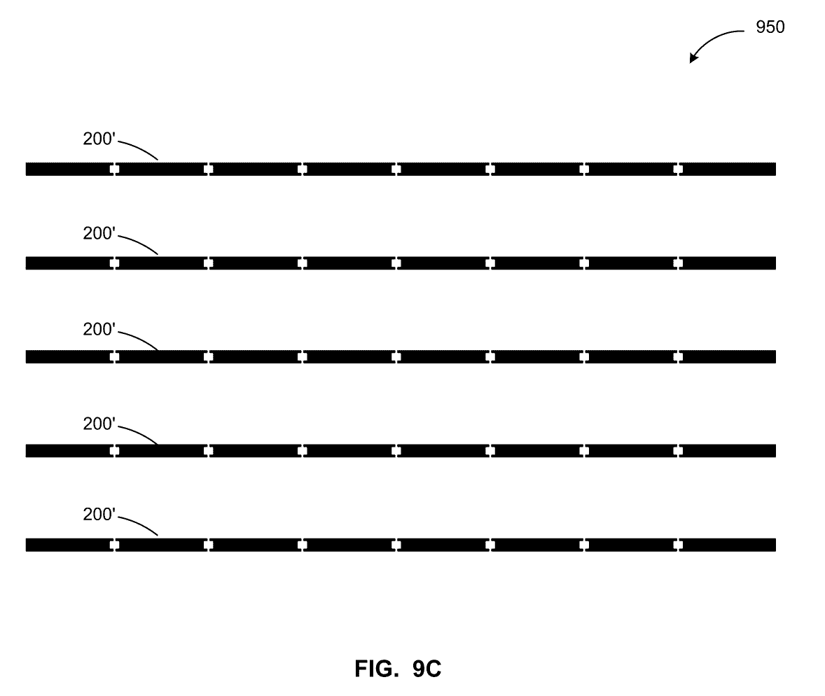

As shown in FIG. 9A, in some embodiments, a membrane 200′ may comprise a series of nanopores 200 to facilitate polymer filtering. Filtration applications may be improved by placing several membranes arranged as parallel layers spaced apart from one another to increase polymer filtration in order to progressively improve the filtration according to polymer length N as shown in FIG. 9B for membranes 200 each having one nanopore with a single enlarged cavity where the nanopores are arranged serially (i.e. co-linear with one another) or as shown in FIG. 9C for several membranes 200′ each having a plurality of nanopores with corresponding cavities and the membranes 200′ being disposed serially with respect to one another so that the plurality of nanopores form columns across the different membranes 200′.

At higher field strengths the driving force may begin to dominate over the effects of entropic trapping such that the translocation time may be almost independent of polymer length up to a certain critical length N* after which it may strongly increase with increasing polymer size N. When the device 800 is operated in this field regime, all polymers below a certain length may translocate the quickest thus yielding filtration of a range of polymer lengths from a sample containing many different lengths.

For these different embodiments of the devices, dynamic tuning is possible where the external force is changeable during use to allow a given nanopore to be dynamically tuned to filter polymers having a first polymer length at a first external force strength and a longer polymer length at a higher external force strength. The external force may be modified when processing a given sample or modified between processing different samples of polymers with the same device or devices with the same or similar geometry (i.e., the same cavity size, but different lengths selected).

The various embodiments of membranes having a nanopore with a cavity described in accordance with the teachings herein may be made using synthetic, solid-state material such as, but not limited to, silicon based materials including silicon nitride, for example. Alternatively, these membranes may be made using biological nanopores. When biological nanopores are used, their interior may be functionalized in different ways such as via point-mutations to groups that have high affinity for a desired reactive group.

At least one of the embodiments described in accordance with the teachings herein may be made by drilling a hole in a layered membrane and then exposing the membrane to an agent to dissolve a portion of the inner layer to form the enlarged cavity while leaving the cis and trans side layers intact.

While the applicant's teachings described herein are in conjunction with various embodiments for illustrative purposes, it is not intended that the applicant's teachings be limited to such embodiments as these the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A membrane for affecting the translocation of polymers therethrough, wherein the membrane comprises:
a first side having a cis opening;
a second side having a trans opening, the second side being located opposite the first side; and
a nanopore extending between the cis opening of the first side to the trans opening of the second side, the nanopore including a cavity that has a cavity size that is selected to affect translation time of polymers having certain chain lengths when the nanopore is influenced by an external force.

2. The membrane of claim 1, wherein the cavity size is selected so that translocation time of polymers across the membrane during use is a non-monotonic function of polymer chain length when a given external force is applied to the nanopore.

3. The membrane of claim 1, wherein an inner portion of the cavity is coaxially aligned with the nanopore.

4. The membrane of claim 1, wherein the cavity has a cylindrical shape, is symmetrically disposed about a longitudinal axis of the nanopore and is wider than a first portion of the nanopore adjacent the cis opening and a second portion of the nanopore adjacent the trans opening.

5. The membrane of claim 4, wherein the cavity has a radius equal to a length of the cavity.

6. The membrane of claim 1, wherein the cavity width is equal to a monomer size of the polymer.

7. The membrane of claim 1, wherein the cis opening and the trans opening have different shapes.

8. The membrane of claim 1, wherein the cis opening and the trans opening have a common shape.

9. The membrane of claim 1, wherein the cavity is asymmetric along the length of the nanopore.

10. The membrane of claim 1, wherein the membrane is a composite membrane with a first layer comprising the cis opening, a second layer comprising the nanopore and a third layer comprising the trans opening.

11. The membrane of claim 1, wherein the membrane comprises at least one additional cis opening, trans opening, and nanopore with an enlarged cavity to facilitate increased polymer filtration.

12. A device for affecting the translocation of polymers, wherein the device comprises:
an input reservoir for containing a plurality of input polymers;
an output reservoir for containing a plurality of translocated output polymers;
a membrane comprising a cis opening, a trans opening and a nanopore having an enlarged cavity, the membrane being fluidly coupled to the input reservoir via the cis opening to receive the input polymers and being fluidly coupled to the output reservoir via the trans opening to provide the translocated output polymers to the output reservoir, the cis opening and the trans opening being disposed on opposite surfaces of the membrane and being coupled to one another by the nanopore; and
an external force source to apply an external force to the nanopore having a strength that is selected based on a cavity size of the cavity and a chain length of a given polymer to affect a translation time of the given polymer across the membrane during use.

13. The device of claim 12, wherein the cavity size is selected so that translocation time of polymers across the membrane during use is a non-monotonic function of polymer chain length when a given external force is applied to the nanopore.

14. The device of claim 12, wherein an inner portion of the cavity is coaxially aligned with the nanopore.

15. The device of claim 12, wherein the cavity has a cylindrical shape, is symmetrically disposed about a longitudinal axis of the nanopore and is wider than a first portion of the nanopore adjacent the cis opening and a second portion of the nanopore adjacent the trans opening.

16. The device of claim 15, wherein the cavity has a radius equal to a length of the cavity.

17. The device of claim 12, wherein the cavity width is equal to a monomer size of the polymer.

18. The device of claim 12, wherein the cis opening and the trans opening have different shapes.

19. The device of claim 12, wherein the cis opening and the trans opening have a common shape.

20. The device of claim 12, wherein the cavity is asymmetric along the length of the nanopore.

21. The device of claim 12, wherein the membrane is a composite membrane with a first layer comprising the cis opening, a second layer comprising the nanopore and a third layer comprising the trans opening.

22. The device of claim 12, wherein the external force source comprises a voltage source with a first terminal coupled to a surface of the membrane having the trans opening and a second terminal of opposite polarity to the first terminal coupled to the cis opening to produce an electric field across the membrane in use.

23. The device of claim 12, wherein the external force source comprises at least one of a pressure source to provide a pressure difference as the external force and a magnetic source to provide a magnetic field as the external force when magnetic beads are attached to the input polymers that permit manipulation of the polymers using magnetic forces.

24. The device of claim 12, wherein the external force is strong enough to cause translocation to occur while not dominating over thermal motion occurring in the cavity.

25. The device of claim 12, wherein the external force is increased during use to cause translocation time to have a strong dependent behavior on polymer length above a certain chain length to allow all polymers below the certain chain length to be translocated quickly across the membrane.

26. The device of claim 12, wherein the external force is disabled during use to trap polymers within the nanopore and the cavity functions as a bioreactor when the cis and trans openings are small enough to present a barrier to the trapped polymer from exiting the cavity.

27. The device of claim 26, wherein at least one surface of the cavity is functionalized with at least one of reactive groups, polymers, and strands of DNA of particular sequences for applications when the nanopore is operated as the bioreactor.

28. The device of claim 12, wherein the membrane comprises a series of filtration units comprising nanopores having a corresponding cis opening, a corresponding trans opening, and an enlarged cavity to facilitate increased polymer filtration.

29. The device of claim 12, wherein the device comprises a plurality of membranes arranged in parallel layers spaced apart from one another to increase polymer filtration with nanopores being aligned across different membranes.

30. The device of claim 12, wherein the nanopores have a common cavity size, a common cavity width and different cavity lengths or different cavity sizes.

31. The device of claim 12, wherein the external force is changeable during use to allow a given nanopore to be dynamically tuned to filter polymers having a first polymer length at a first external force strength and a different polymer length at a different external force strength.
